(19) United States
(12) Patent Application Publication
(10) Pub. No.: US 2016/0295898 A1
(43) Pub. Date: Oct. 13, 2016

(54) STABILIZATION OF HEATED FOOD SUBSTRATES

(71) Applicant: Crisp Sensation Holding S.A., Geneva (CH)

(72) Inventors: Wilhelmus Johannes Gerardus Michiels, Nederweert (NL); Bianca Van der Kolk, 's-Hertogenbosch (NL)

(21) Appl. No.: 14/683,752

(22) Filed: Apr. 10, 2015

(51) Int. Cl. A23L 1/31; A23L 3/3562; A23L 1/01

(52) U.S. Cl. CPC A23L 1/3103; A23L 1/01; A23L 3/3562; A23V 2002/00

(57) ABSTRACT

A method of manufacture of a food product configured to be reheated in a microwave, thermal or convection oven, comprising wholly or partially impregnating a substrate with a stabilizer composition; wherein the stabilizer composition includes: one or more gums selected from the group consisting of carrageenan gums; locust bean gum; guar gum; xanthan gum; gellan gum and mixtures thereof in a concentration of 5 wt % to 30 wt %; salt selected from sodium chloride, potassium chloride and combinations thereof in a concentration of 10 wt % to 50 wt %; one or more polyglucose components selected from the group consisting of maltodextrin; polydextrose; starch and combinations thereof in a concentration of 20 wt % to 60 wt %, calculated by weight of dry matter; a phosphate component in a concentration of 0 to 7.4 wt %; and optional further edible ingredients in a concentration of 0 to 40 wt %; wherein the concentration ranges given add up to total 100 wt %.

### FIELD OF THE DISCLOSURE

This invention relates to food products which are stabilized to retain moisture during cooking or reheating in a microwave or thermal oven. This invention relates particularly but not exclusively to food products comprising a substrate or core and a surrounding coating, for example a breaded or battered product. The invention also relates to non-coated food products and to stabilizer compositions for use in manufacture of such products. The invention further relates to methods of stabilization of the food products. In particular embodiments of the invention the core comprises a meat product, especially whole muscle or bone-in meat.

### BACKGROUND

This invention finds particular but not exclusive application in relation to products which are cooked or reheated in a thermal oven.

Many food materials, for example natural muscle of poultry, fish or red meat, vegetable or processed foods contain a large percentage of water. Most fresh foods contain more than 60% water. Some of this water is bound, that is tightly attached to the constituent cells. The remaining mobile water is available and can be frozen. If a food product is frozen to a core temperature of between −1° C. and −30° C. or lower and is irradiated in a microwave oven, the microwave energy will be primarily absorbed by the frozen available water.

Whereas in conventional cooking heat is applied from the exterior, in microwave cooking heat is generated from within. The process of heating can be very rapid so that available water is converted into steam. When a food product is allowed to stand after heating in a microwave oven, water can continue to be expelled from the product. This is particularly noticeable for example when heating frozen fish muscle. The loss of water causes any food coating, particularly a batter, pastry or breadcrumb coating to become soggy and unpalatable. In addition the core of the substrate may become dry due to the loss of water.

Attempts have been made to limit the escape of moisture during microwave cooking by coating the product with a composition which forms an impermeable film. This is unsatisfactory because the natural distribution of water within the coated product is lost through any coating as steam and due to internal pressure. Furthermore an impenetrable coating or film is detrimental to the taste and mouth feel of the product.

WO97/03572 discloses a method of stabilizing a microwave cookable or reheatable food material by impregnation of the product with a stabilizer composition comprising cellulose gum, modified starch, polydextrose, xanthan gum, egg albumen and pea starch.

Products which are cooked or reheated in a thermal oven or microwave/thermal combination oven also require stabilization to prevent loss of moisture while retaining succulence. It is convenient if the same stabilizer and process for use can be employed for both microwave and thermal applications.

### SUMMARY

According to a first aspect of the present invention a method of manufacture of a food product configured to be heated in a microwave, thermal or combination oven, wherein the method comprises wholly or partially impregnating a substrate with a stabilizer composition;

wherein the stabilizer composition includes:

one or more gums selected from the group consisting of carrageenan gums; locust bean gum; guar gum; xanthan gum; gellan gum and mixtures thereof in a concentration of 5 wt % to 30 wt %, calculated by weight of dry matter;

salt selected from sodium chloride, potassium chloride and combinations thereof in a concentration of 10 wt % to 50 wt %;

one or more polyglucose components selected from the group consisting of maltodextrin; polydextrose; starch and combinations thereof in a concentration of 20 wt % to 60 wt %, calculated by weight of dry matter;

a phosphate component in a concentration of 0 to 7.4 wt %, calculated by weight of dry matter; and

optional further edible ingredients in a concentration of 0 to 40 wt %, calculated by weight of dry matter;

wherein the concentration ranges given add up to total 100 wt %.

According to a second aspect of the present invention, there is provided a food product including a substrate impregnated with a stabilizer composition by a method in accordance with the first aspect of this invention.

The substrate may include pieces of: meat, poultry, fish, vegetable, fruit or dairy food.

### DETAILED DESCRIPTION OF THE PRESENT DISCLOSURE

The invention finds particular application with meat substrates, especially whole muscle or bone-in meat substrates. In particularly advantageous embodiments the substrate may comprise whole muscle meat, such as chicken breast. Alternatively the substrate may comprise bone-in chicken, leg or wing portions or meat chops.

The stabilizer composition may be provided as an aqueous composition, preferably with a dry matter content of about 20 wt % to about 40 wt %, more preferably about 30 wt % to about 35 wt %, typically about 30 wt % or about 34 wt %.

The aqueous stabilizer composition is preferably a free flowing or non-viscous liquid to facilitate penetration into the substrate by permeation or injection as described below.

The viscosity at 20° C. is preferably in the range 1 to 1950 cP, preferably 3 to 1000 cP measured using a Brookfield viscometer with a No. 63 spindle at 60 rpm at 20° C.

The gum component is preferably present in a concentration, calculated by weight of dry matter, more preferably of about 8 wt % to about 18 wt %, even more preferably about 10 wt % to about 16 wt %, yet more preferably about 12 wt % to about 14 wt %, most preferably about 13 wt %.

The gum component preferably comprises a mixture of two or more gums. A mixture of kappa carrageenan gum and iota carrageenan gum is particularly advantageous. A gum component including a mixture of kappa carrageenan gum to iota carrageenan gum in a ratio by weight in the range of about 1 to about 5:1, preferably about 2:1 to about 4:1, more preferably about 3:1 is particularly advantageous. Gellar gum or pectin may also be employed in place of or in addition to carrageenan gum.

One or more further gums may be included in the gum component. For example one or more of: locust bean gum, xanthan gum, gum Arabic or agar agar may be used to increase the firmness of the gel formed by the gum component.

Use of methyl cellulose, carboxymethyl cellulose, hydroxypropylmethyl cellulose or ethyl cellulose is not preferred. Combinations of xanthan gum with locust bean gum or kanjac gum may be employed, for example a 1:1 ratio by dry weight, particularly for products which are cooked to a high core temperature of about 80° C. Use of guar gum as the sole gum is not preferred but guar gum may be used in combination with one or gums which provide gelatin at relatively lower temperatures.

Salt is preferably present in a concentration, calculated by weight of dry matter, more preferably of about 20 wt % to about 40 wt %, even more preferably about 25 wt % to about 35 wt %, most preferably about 32 wt %. Preferably, the salt employed is sodium chloride.

The polyglucose component may serve as a filler and is preferably selected from the group consisting of maltodextrin, polydextrose and mixtures thereof. Especially preferred is maltodextrin. The polyglucose component is preferably present in a concentration, calculated by weight of dry matter, of about 20 wt % to about 60 wt %, more preferably about 30 wt % to about 55 wt %, even more preferably about 32 wt % to about 55 wt %, most preferably 35 wt % to about 49 wt %. Use of the polyglucose additive helps to reduce the size of crystals formed when the impregnated product is frozen. It has been found that an undesirable reaction occurs when frozen products containing large crystals are reheated.

The preferred stabilizer compositions do not include gelatine. Use of gelatine is undesirable as it reacts with water on the surface of a meat or other substrate to form an undesirable sticky layer which would not promote adhesion of any coating layer to the substrate. Gelatin may also block the injector needles.

The phosphate component may be selected from the group consisting of (mono)phosphate, diphosphate, triphosphate, hexametaphosphate, polyphosphate and combination thereof. Preferably the phosphate component is a (mono)phosphate. A suitable mixture is sold under the trade mark Carnal 822. The phosphate component is preferably present in a concentration, calculated by weight of dry matter, more preferably of 4.3 wt % to 7.4 wt %, even more preferably 5 wt % to 7 wt %, more preferably 6 wt % to 7 wt %, most preferably about 6.5 wt %.

The composition may optionally further comprise cellulose ether, particularly for use with microwaveable food products.

Where present the cellulose ether concentration is preferably in the range of about 3 wt % to about 20 wt %, more preferably about 7 wt % to about 13 wt %, most preferably about 10 wt %, calculated by weight on dry matter. Preferably, the cellulose ether is methyl cellulose.

The stabilizer composition is particularly advantageous with larger dimensioned substrates or bone-in substrates for which permeation into the substrate may be difficult to achieve.

A particularly advantageous may comprise successive steps of:

a) impregnation;

b) application of pre-dust;

c) oven cooking;

d) freezing;

e) application of pre-dust;

f) coating with a gel composition;

g) application of a first crumb layer;

h) application of a second crumb layer;

i) frying (optional)

j) freezing (optional).

In preferred embodiments the step of partially or wholly impregnating the substrate may include the step of injecting the substrate with an array of hollow needles connected to a reservoir containing the stabilizer composition. A multiple needle injector may be employed. Side opening needles are preferably used, for example having a diameter of 2 mm.

Preferably the injector has an array of needles which are individually controllable using air pressure. Optiflex® needles may be used. The needles may be arranged in a fine pattern. A two stroke pattern may be used.

A preferred injector is manufactured under the registered trade mark Gea AccuJector 450.

A minimum amount of the stabilizer composition is preferably impregnated into the substrate so that a minimum amount of water is introduced into the substrate.

The substrate is preferably impregnated with an amount of stabilizer composition of 5 wt % to 15 wt %, typically about 10 wt % by the weight of the stabilized substrate.

For bone-in products and other products, following impregnation, the substrate pieces may be tumbled in a tumble mixer until they are dry. The time taken to obtain dry substrate pieces may vary dependent on the nature of the substrate. Larger pieces for example, chicken fillets or drumsticks with a weight about 125 g may be tumbled for 30 minutes. Smaller pieces with weights about 50-75 g for 20 to 25 minutes. Tumbling for larger periods is not preferred due to possible protein extraction from the meat.

When the tumbled substrate pieces are dry, a pre-dust may be applied. The pre-dust may be a conventional seasoned flour composition.

Preferably, the pre-dust comprises a water resistant powdered crumb resultant from milling crumb which has been extruded with guar gum, xanthan gum or other hydrocolloid, as disclosed in WO2010/001101, the disclosure of which is incorporated into this specification by reference for all purposes.

The pre-dust may have a particle size less than 0.8 mm.

The pre-dust coated product is preferably fully cooked, typically using a thermal oven, for example a Gea Cookstar (Registered Trade Mark) oven having a conveyor speed of about 2 m/second at 160° C. for about 20 minutes, dependent on the size and nature of the product.

For bone-in products, preferably a minimum core temperature of 80° C. is achieved to prevent occurrence of bloodspots.

The cooked product may be frozen and is preferably introduced into a freezer before the core temperature of the substrate falls below 65° C., preferably 70° C. The process is disclosed in WO2012/101025, the disclosure of which is incorporated into this specification by reference for all purposes. A gyro freezer at −40° C. may be used. The freezing time may be 35 minutes using a conveyor speed of 2.0 m/second. A core temperature of −20° C. or less should be achieved within a period of 5 minutes, preferably within a period of 2 minutes after removal from the oven.

A predust consisting of a powder or fine particulate coating is preferably applied to the frozen stabilized substrate pieces. The composition of the coating may depend on the nature of the intended heating process.

For an ovenable coating system, the coating may comprise a pre-dust consisting of:

| Ingredient | % |
|---|---|
| fine breadcrumbs, less than 0.8 mm (Crumb AO) | 59 |
| wheat starch (Briljant) | 40 |
| vegetable oil | 1 |
| Total | 100 |

The crumb may be a gum impregnated crumb manufactured in accordance with the disclosure of WO2010/001101.

The pre-dust coated frozen substrate is preferably coated with an aqueous gel-like coating solution using a tempura applicator. The composition of the solution (referred to as PD8) was:

| Ingredient | % |
|---|---|
| cellulose gum (Methocel A4M) | 25.0 |
| modified starch (Thermflo) | 35.0 |
| xanthan gum | 25.0 |
| egg albumen | 15.0 |
| Total | 100.0 |

Alternatively a standard batter composition may be employed.

The gel coated substrate pieces may be coated with a first layer of gum impregnated crumb manufactured in accordance with WO2010/001101 and having a dimension from 1.5 mm to 2.5 mm or 2.0 mm to 3.15 mm, typically followed by a second infill coating of crumb with a size range of 0.8 mm to 1.5 mm or 0.8-2.0 mm.

The crumb coated product preferably is fried, e.g. in hot oil at 180° C. for 2 minutes, and frozen at −40° C. using a Gyro freezer. The frozen products may be packaged for storage and distribution.

For a microwavable coating system the frozen cooked products may be coated with an aqueous solution comprising 1% PD8 (mentioned above) following which a first crumb coating with a size less than 0.8 mm may be applied followed by a further application of aqueous coating and successive applications of crumb with a dimension from 2.0 mm to 3.15 mm and 0.8 mm to 2.0 mm. The crumb coated product may be fried at 180° C. for 2 minutes 30 seconds followed by cryogenic freezing and packaging.

For chicken fillets a similar process may be used with injection followed by tumbling until dry, following which the product may be allowed to rest overnight before cooking and freezing as described above.

The products manufactured in accordance with the process described above are crispy and have succulent meat.

A soya batter may be used in place of the PD8 for ovenable products.

The invention is further described by means of example, but not in any limitative sense.

### Example 1

A stabilizer composition was prepared by mixing the following ingredients:

| | |
|---|---|
| kappa carrageenan gum/iota carrageenan gum mixture 3:1 w/w | 13% |
| sodium chloride | 32% |
| maltodextrin | 38.5% |
| sodium phosphate (Carval 822) | 6.5% |
| methyl cellulose (Methocel A4M) | 10% |
| Total | 100% |

The mixture was dissolved in water to form a solution having a solids content of 34 wt % and a viscosity at 20° C. of 100 cP measured using a Brookfield viscometer with a No 63 spindle.

20 chicken fillets each having a weight of 125 g were placed in a Gea AccuJector 450 injector and were injected with the stabilizer solution until a weight increase of 10% was obtained. Following the injection the chicken pieces were placed in a tumble mixer and tumbled for 30 minutes. After this period the pieces had a dry appearance.

A predust was prepared using water resistant dust (particle size<0.8 mm) obtained by milling crumb manufactured in accordance with WO2010/001101 and dried to a water content of 1.5 wt %. The impregnated chicken pieces were coated with the predust.

The predust (<0.8 mm) coated chicken pieces were cooked at 160° C. for 20 minutes in a Gea Cookstar (registered trade mark) conveyor oven having a conveyor speed of 2 m/sec.

The cooked chicken pieces were removed from the oven and were immediately placed into a giro freezer maintained at −40° C. The period between removal from the oven and insertion into the freezer was 1.5 minutes or less. The freezing time was 35 minutes and the conveyor speed was 2 m/sec. The core temperature of the product after freezing for two minutes was determined to be −20° C. or lower.

A predust coating was applied to the frozen pieces. The predust consisted of

| Ingredient | % |
|---|---|
| fine breadcrumbs, less than 0.8 mm (Crumb AO) | 59%; |
| wheat starch (Briljant) | 40%; |
| vegetable oil | 1%. |
| Total | 100% |

The predust coated pieces were passed through a tempura applicator containing an aqueous coating composition (fully hydrated gel) that was prepared using a powder mixture consisting of:

| | % |
|---|---|
| Modified starch (Thermoflo) | 35 |
| Thickener Methocel A4M | 25 |
| Xanthan gum | 25 |
| Egg albumen | 15 |
| Total | 100 |

The powder mixture was dissolved in water to form a 1% solution, and was left to stand for minimum 1 hour to form a fully hydrated gel.

The pickup of the gel composition was about 6% to 8%. The gel coated pieces were then fried at 180° C. for 2 minutes 30 seconds followed by cryogenic freezing as described above and packaging.

1. A method of manufacture of a food product configured to be reheated in a microwave, thermal or combination oven, the method comprising wholly or partially impregnating a substrate with a stabilizer composition;
wherein the stabilizer composition comprises:
one or more gums selected from the group consisting of carrageenan gums; locust bean gum; guar gum; xanthan gum; gellan gum and mixtures thereof in a concentration of 5 wt % to 30 wt %, calculated by weight of dry matter;
salt selected from sodium chloride, potassium chloride and combinations thereof in a concentration of 10 wt % to 50 wt %;
one or more polyglucose components selected from the group consisting of maltodextrin; polydextrose; starch and combinations thereof in a concentration of 20 wt % to 60 wt %, calculated by weight of dry matter;
a phosphate component in a concentration of 0 to 7.4 wt %, calculated by weight of dry matter; and
optional further edible ingredients in a concentration of 0 to 40 wt %, calculated by weight of dry matter;
wherein the concentration ranges given add up to total 100 wt %.

2. A method as claimed in claim 1, wherein the stabilizer composition is an aqueous composition with a dry matter content of about 20 wt % to about 40 wt %, preferably about 30 wt % to about 35 wt %.

3. A method as claimed in claim 1, wherein the substrate is whole muscle or bone-in meat.

4. A stabilizer composition as claimed in claim 1, wherein the gum component is present in a concentration, calculated by weight of dry matter, of about 8 wt % to about 18 wt %, preferably about 10 wt % to about 16 wt %, more preferably about 12 wt % to about 14 wt %, most preferably about 13 wt %.

5. A method as claimed in claim 1, wherein the gum component is selected from the group consisting of: mixtures of kappa carrageenan gum and iota carrageenan gum, gellan gum or pectin.

6. A method as claimed in claim 1, wherein the weight ratio of kappa carrageenan gum to iota carrageenan gum is in the range of about 1 to 5:1, preferably 2:1 to about 4:1; more preferably, about 3:1.

7. A method as claimed in claim 1, comprising one or more additional gums selected from the group consisting of: locust bean gum, xanthan gum, gellan gum and mixtures thereof.

8. A method as claimed in claim 1, wherein the salt is present in a concentration, calculated by weight of dry matter, of about 20 wt % to about 40 wt %, more preferably about 25 wt % to about 35 wt %, most preferably about 32 wt %.

9. A method as claimed in claim 1, wherein the polyglucose component is maltodextrin.

10. A method as claimed in claim 9, wherein the polyglucose component is present in a concentration, calculated by weight of dry matter, in the range from about 30 wt % to about 55 wt %, more preferably about 32 wt % to about 55 wt %, most preferably about 35 wt % to about 49 wt %.

11. A method as claimed in claim 1, wherein the phosphate component is selected from the group consisting of phosphate, diphosphate, triphosphat, hexametaphosphate, polyphosphate and combinations thereof.

12. A method as claimed in claim 1, wherein the phosphate component is present in a concentration, calculated by weight of dry matter, of 4.3 wt % to 7.4 wt %, preferably 5 wt % to 7 wt %, more preferably 6 wt % to 7 wt %, most preferably 6.5 wt %.

13. A method as claimed in claim 1, wherein the stabilizer composition contains 3-30 wt % of cellulose ether, calculated by weight of dry matter.

14. A method as claimed in claim 1, wherein the step of impregnating the substrate with a stabilizer composition comprises injecting the substrate with the stabilizer solution, using a multiple needle injector.

15. A method as claimed in claim 11, wherein the substrate is impregnated with 5 wt % to 15 wt % of the stabilizer composition, calculated by weight of the stabilized substrate.

16. A method as claimed in claim 11, further comprising the step of tumbling the impregnated substrate until the exterior of the substrate is dry.

17. A method as claimed in claim 1, further comprising the step of:
applying a predust to coat the impregnated substrate; cooking the coated substrate; and immediately freezing the cooked substrate.

18. A method as claimed in claim 1, wherein the substrate comprises pieces of: meat, poultry, fish, vegetable, fruit or dairy food.

19. A method as claimed in claim 18, wherein the substrate comprises whole muscle or bone-in meat.

20. A food product comprising a substrate impregnated with a stabilizer composition by a method as claimed in claim 1.

21. A food product as claimed in claim 20, wherein the substrate comprises pieces of: meat, poultry, fish, vegetable, fruit or dairy food.

22. A food product as claimed in claim 21, wherein the substrate comprises whole muscle or bone-in meat.
